(19) United States
(12) Patent Application Publication
(10) Pub. No.: US 2021/0406688 A1
(43) Pub. Date: Dec. 30, 2021

(54) METHOD AND DEVICE WITH CLASSIFICATION VERIFICATION

(71) Applicant: Samsung Electronics Co., Ltd., Suwon-si (KR)

(72) Inventors: Seongmin OK, Suwon-si (KR); Young-Seok KIM, Suwon-si (KR); Hwidong NA, Suwon-si (KR); Sanghyun YOO, Suwon-si (KR); Hoshik LEE, Suwon-si (KR); Junhwi CHOI, Suwon-si (KR)

(73) Assignee: Samsung Electronics Co., Ltd., Suwon-si (KR)

(21) Appl. No.: 17/469,590

(22) Filed: Sep. 8, 2021

Related U.S. Application Data
(63) Continuation of application No. PCT/KR2020/006309, filed on May 13, 2020.

(30) Foreign Application Priority Data
May 13, 2019 (KR) 10-2019-0055544
May 13, 2020 (KR) 10-2020-0057370

(51) Int. Cl. G06N 3/08; G06N 3/04; G06K 9/62

(52) U.S. Cl. CPC G06N 3/08; G06N 3/0454; G06K 9/623; G06K 9/6215; G06K 9/6262

(57) ABSTRACT

A method and computing device with classification verification is provided. A processor-implemented method includes implementing a classification neural network to generate a classification result of data input to the classification neural network by generating, with respect to the input data, intermediate hidden values of one or more hidden layers of the classification neural network, generating the classification result of the input data based on the generated intermediate hidden values, and generating a determination of a reliability of the classification result by implementing a verification neural network, input the intermediate hidden values, to generate the determination of the reliability.

### CROSS-REFERENCE TO RELATED APPLICATIONS

This application is a Continuation of International Application No. PCT/KR2020/006309, filed on May 13, 2020, which claims the benefit under 35 USC § 119(a) of Korean Patent Application Nos. KR 10-2019-0055544 and KR 10-2020-0057370, respectively filed on May 13, 2019 and May 13, 2020 in the Korean Intellectual Property Office, the entire disclosures of all of which are incorporated herein by reference for all purposes.

### BACKGROUND

### 1. Field

The following description relates to a method and device with classification verification.

### 2. Description of Related Art

A neural network may be used to classify predetermined objects or patterns represented in input data that may include information of such objects or patterns, such as in an input image information. For example, when a predetermined image is input to the neural network, the neural network may analyze the predetermined image for objects or patterns, as non-limiting examples, and may output data in a form of a probability value, e.g., of whether or which such example objects or patterns were more likely or less likely in the predetermined image.

However, input data to a neural network may be substantially different from training data that was used in the training of the neural network.

### SUMMARY

In one general aspect, a processor-implemented method includes implementing a classification neural network to generate a classification result of data input to the classification neural network by generating, with respect to the input data, intermediate hidden values of one or more hidden layers of the classification neural network, generating the classification result of the input data based on the generated intermediate hidden values, and generating a determination of a reliability of the classification result by implementing a verification neural network, input the intermediate hidden values, to generate the determination of the reliability.

The intermediate hidden values may include hidden values of two or more hidden layers, as respective outputs of the two or more hidden layers, among a plurality of hidden layers of the classification neural network.

The method may further include verifying the classification result of the input data when the generated determination of the reliability of the classification result meets a predetermined verification threshold.

The method may further include selectively controlling performance of operations of a computing device based on whether the classification result is verified.

The verification neural network may include at least five hidden layers.

The classification neural network may include at least five hidden layers.

The method may further include training a temporary verification neural network, to become the verification neural network, by inputting to the temporary verification neural network hidden values of the classification neural network corresponding to a training data and a known reliable classification result of the classification neural network corresponding to the training data, and adjusting parameters of the temporary verification neural network toward generating an accurate verification of the known reliable classification result.

The method may further include generating sample data from the training data, where the temporary verification neural network is trained based on attribute information of the training data and a distance between the training data and the sample data using a reliability model.

In the reliability model, a reliability may decrease when a distance between a central point corresponding to the training data and a sample point corresponding to sample data increases.

The training of the temporary verification neural network may include using either of a first reliability model that determines a reliability of a sample point corresponding to sample data with an attribute similar to the training data based on a distance between the sample point and a first central point corresponding to the training data, or a second reliability model that determines a reliability of the sample point corresponding to the sample data with another attribute similar to the training data based on a distance between the sample point and a second central point corresponding to the training data and based on a gradient direction of the central point that is attribute information of the training data.

The method may further include obtaining a score of a central point corresponding to the hidden values of the classification neural network corresponding to the training data, determining a score of a sample point corresponding to sample data randomly generated around the central point, and performing the training of the temporary verification neural network based on the score of the central point and the score of the sample point.

The method may further include training a temporary classification neural network, with respect to a training input, to become the classification neural network, and training a temporary verification neural network, to become the verification neural network, where the training of the temporary verification neural network may include inputting intermediate hidden values of the temporary classification neural network, with respect to the training input, to the temporary verification neural network with respect to a training classification result of the temporary classification neural network for the training input.

In one general aspect, one or more embodiments include a non-transitory computer readable medium including instructions, which when executed by a processor, configure the processor perform any one, any combination, or all operations and methods described herein.

In one general aspect, a processor-implemented method includes generating, with respect to training data input to a classification neural network, intermediate hidden values of one or more hidden layers of the classification neural network, and training the verification neural network based on a reliability model and the intermediate hidden values.

The method may further include implementing the trained classification neural network to generate a classification result of input data through respective processes of one or more hidden layers of the trained classification neural network, implementing the trained verification neural network, input hidden values of the respective processes of the one or more of hidden layers, to generate a determination of a reliability of the classification result.

The training of the verification neural network may be based on attribute information of the training data and a distance between the training data and sample data generated, from the training data, using the reliability model.

The method may further include obtaining a score of a central point corresponding to the intermediate hidden values, determining a score of a sample point corresponding to sample data randomly generated around the central point, and performing the training of the verification neural network based on the score of the central point and the score of the sample point.

In the reliability model, a reliability may decrease when a distance between a central point corresponding to the training data and a sample point corresponding to sample data increases.

The training of the verification neural network may further include either of a first reliability model that determines a reliability of a sample point corresponding to sample data with an attribute similar to the training data based on a distance between the sample point and a first central point corresponding to the training data, or a second reliability model that determines a reliability of a sample point corresponding to the sample data with another attribute similar to the training data based on a distance between the sample point and a second central point corresponding to the training data and based on a gradient direction of the central point that is attribute information of the training data.

The verification neural network may include at least five hidden layers.

The classification neural network may include at least five hidden layers.

In one general aspect, a non-transitory computer readable medium includes instructions, which when executed by a processor, control the processor to implement at least one of a classification neural network and a verification neural network, the classification neural network configured to generate a classification result of data input to the classification neural network, and the verification neural network configured to generate a reliability determination of the classification result based on intermediate hidden values, of one or more hidden layers of the classification neural network, generated within the classification neural network by the generation of the classification result.

The medium may further include another verification neural network configured to generate another reliability determination of the classification result based on hidden values of at least one hidden layer of the classification neural network generated within the classification neural network by the generation of the classification result, and the instructions may further include instructions, which when executed by the processor, control the processor to implement the classification neural network, implement the verification neural network and the other verification neural network to determine respective reliabilities of the classification result, and determine a final reliability of the classification result based on the determined respective reliabilities.

In one general aspect, a computing device, includes a processor, and a memory including a classification neural network configured to generate a classification result of data input to the classification neural network, and a verification neural network configured to generate a reliability determination of the classification result based on intermediate hidden values, of one or more hidden layers of the classification neural network, generated within the classification neural network in the generation of the classification result, where the processor is configured to selectively control operations of the computing device based on whether a result, of an implementation of the classification neural network for the input data and implementation of the verification neural network with respect to the classification result, verified the classification result.

The memory may further include another verification neural network configured to generate another reliability determination of the classification result based on hidden values of at least one hidden layer of the classification neural network generated within the classification neural network by the generation of the classification result, and the selective control of the operations of the computing device may be based on whether combined results, of respective implementations of the verification neural network and the other verification neural network with respect to the classification result, verified the classification result.

In one general aspect, a computing device includes a processor configured to implement a classification neural network to generate a classification result of data input to the classification neural network by generation of, with respect to the input data, intermediate hidden values of one or more hidden layers of the classification neural network, and generation of the classification result of the input data based on the generated intermediate hidden values, and generate a determination of a reliability of the classification result by implementing a verification neural network, input the intermediate hidden values, to generate the determination of the reliability.

The intermediate hidden values may include hidden values of two or more hidden layers, as respective outputs of the two or more hidden layers, among a plurality of hidden layers of the classification neural network.

The processor may be further configured to verify the classification result of the input data when the generated determination of the reliability of the classification result meets a predetermined verification threshold.

The processor may be further configured to selectively control performance of operations of the device based on whether the classification result is verified.

The verification neural network may include at least five hidden layers.

The classification neural network may include at least five hidden layers.

In one general aspect, a computing device includes a classification neural network configured to generate a classification result of data input to the classification neural network, a verification neural network configured to generate a reliability determination of the classification result based on intermediate hidden values, of one or more hidden layers of the classification neural network, generated within the classification neural network by the generation of the classification result, a processor configured to implement the classification neural network and the verification neural network.

The device may further include another verification neural network configured to generate another reliability determination of the classification result based on hidden values at least one hidden layer of the classification neural network, generated within the classification neural network by the generation of the classification result, where the processor may be further configured to implement the other verification neural network, and to verify the classification result of the input data based on the reliability determination and the other reliability determination.

The processor may be configured to verify the classification result of the input data when the reliability determination meets a predetermined verification threshold.

The processor may be configured to selectively control performance of operations of the device based on whether the classification is verified.

The classification neural network may be a convolutional neural network (CNN).

The classification neural network may include at least five hidden layers.

The verification neural network may be a CNN.

The verification neural network may include at least five hidden layers.

The input data may be image data.

The input may be is audio data.

The classification neural network may include an input layer, an output layer, and a plurality of hidden layers, and the intermediate hidden values include outputs of a hidden layer closer to the output layer than the input layer.

Other features and aspects will be apparent from the following detailed description, the drawings, and the claims.

### BRIEF DESCRIPTION OF THE DRAWINGS

FIG. 1 illustrates an example of a classification neural network and a verification neural network.

FIG. 2 illustrates an example of unreliable classification results determined by a classification neural network.

FIG. 3 illustrates an example of a process of training a verification neural network.

FIG. 4 illustrates an example of a process in which a verification neural network determines a reliability of a classification result.

FIG. 5 illustrates an example of a process of determining a score of a sample point to train a verification neural network.

FIG. 6 illustrates examples of reliability models that may be used to train a verification neural network to determine a reliability of a classification result.

FIG. 7 is a flowchart illustrating an example of a process of training a verification neural network.

FIG. 8 is a flowchart illustrating an example of a process in which a verification neural network determines a reliability of a classification result of input data.

FIG. 9 illustrates an example of a computing device or system that includes a classification neural network and a verification neural network, and which outputs a verified classification result of the classification neural network.

Throughout the drawings and the detailed description, unless otherwise described or provided, the same drawing reference numerals will be understood to refer to the same or like elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, some descriptions of features that are known after an understanding of the disclosure of this application may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Although terms of “first” or “second” are used to explain various components, the components are not limited to the terms. These terms should be used only to distinguish one component from another component. For example, a “first” component may be referred to as a “second” component, or similarly, and the “second” component may be referred to as the “first” component within the scope of the right according to the concept of the present disclosure.

It will be understood that when a component is referred to as being “connected to” another component, the component can be directly connected or coupled to the other component, or intervening components may be present.

As used herein, the singular forms “a,” “an,” and “the” are intended to include the plural forms as well, unless the context clearly indicates otherwise. It should be further understood that the terms “comprises” and/or “comprising,” when used in this specification, specify the presence of stated features, integers, operations, elements, components or a combination thereof, but do not preclude the presence or addition of one or more other features, integers, operations, elements, components, and/or groups thereof. The use of the term “may” herein with respect to an example or embodiment (e.g., as to what an example or embodiment may include or implement) means that at least one example or embodiment exists where such a feature is included or implemented, while all examples are not limited thereto.

Unless otherwise defined herein, all terms including technical or scientific terms used herein have the same meaning as commonly understood by one of ordinary skill in the art to which examples belong based on an understanding of the disclosure of this application. It will be further understood that terms, such as those defined in commonly-used dictionaries, should be interpreted as having a meaning that is consistent with their meaning in the context of the relevant art and the disclosure of this application and will not be interpreted in an idealized or overly formal sense unless expressly so defined herein.

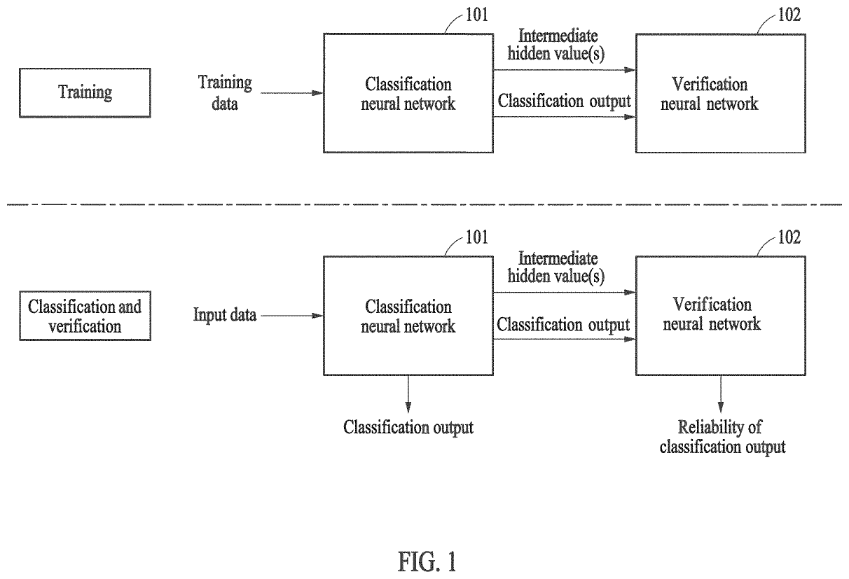

FIG. 1 illustrates an example of a classification neural network and a verification neural network.

As an example, when the classification neural network classifies information of an image or speech, as non-limiting examples of input data to the classification neural network, as being of a particular class, additional processes may be implemented to determine whether this classification result of the classification neural network is appropriate to be relied on with respect to further predetermined applications.

Accordingly, as an example, FIG. 1 illustrates a classification neural network 101 and a verification neural network 102. Each of the classification neural network 101 and the verification neural network 102 may be defined as respective neural networks including a plurality of layers, or respective portions of a same neural network. The neural network(s) may be, for example, a convolutional neural network (CNN) or include convolutional layers and may include an input layer, a plurality of hidden layers, and an output layer. For example, the neural network(s) may be representative of each network including at least five hidden layers, at least ten hidden layers, at least twenty hidden layers or at least thirty hidden layers, etc., as non-limiting examples. Herein, hidden layers mean layers other than the output layer, and other than an input layer when the input layer merely forwards a received input to one or more subsequent hidden layers, e.g., without any trained activation or other operations on the input being performed by the input layer. For example, if any input to a neural network is directly to a convolution layer, the convolution layer is considered a hidden layer, and an output of the convolution layer may be considered an example of hidden values. In most typical neural networks, hidden layers are the one or more layers between, or intermediate of, the input layer and the output layer. In one or more examples, hidden values mean a resultant value, e.g., after an operation or activation, of a corresponding hidden layer that are generated by the hidden layer, such as for provision to a next layer of the neural network and/or for input to the same hidden layer at a previous and/or subsequent time.

The classification neural network 101 may perform a classification process of determining which pattern or object is represented by input data. The classification neural network 101 may be provided the input data and, through a plurality of hidden layers, the classification neural network 101 may determine a class, among a plurality of trained classes, such as a particular object or type of object or particular pattern or type of pattern represented in/by the input data. For example, each hidden layer of the classification neural network 101 may filter resultant data generated by a previous layer with increased abstraction, for example, and provide the result of that generation to a next hidden layer or an output layer, as a non-limiting example. For example, when the input data is an image, the classification neural network 101 may classify the image into one class among a plurality of classes, for example, dogs, cats, airplanes, ships, people, traffic lights, vehicles, or bicycles respective classes. The classification neural network 101 may determine the classified class, from other classification results of the classification neural network 101, as the classification result having a highest score among the classifiable classes.

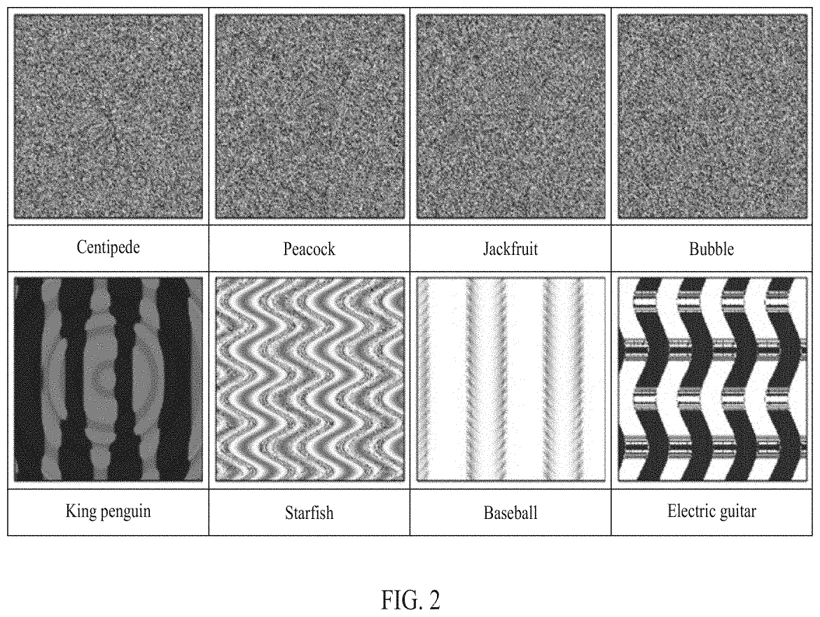

The input data may be similar to the training data that was used to train a neural network that ultimately became the trained classification neural network 101, e.g., where the training was performed to properly classify varied training data through a training process, in which case the classification result of the classification neural network 101 may be considered to have a high reliability, and which will then be made available to, or then used by, subsequent application(s). However, when the input data is not sufficiently similar to the training data, the classification result of the classification neural network 101 may have a relatively low reliability. For example, as discussed further below with respect to FIG. 2, a non-limiting example of such an insufficiently similar input may be an input image that would appear unrelated to a classification result (e.g., output class), or unrelated to an expected corresponding training input that would have been used when training the corresponding classification neural network with respect to that class, such as where the input image may have been specifically designed to fool or spoof the classification neural network to incorrectly classify or recognize the input image. Thus, the reliability of the classification result of the classification neural network 101 may be calculated.

A calculated reliability of a classification result of the classification neural network 101 may be used to determine whether to use the classification result, e.g., in one or more subsequent operations, or to reject the classification result. For example, when respective classification neural networks 101 are used to classify data for various applications, for example, face recognition, autonomous driving, or voice recognition, the determined respective reliabilities of the respective classification results may be considered as, or used to estimate, an uncertainty of the respective classification results of the respective classification neural networks 101. As noted above, when the reliability of a classification result is greater than a predetermined reference value, the computing device or system may be controlled to use the classification result in one or more first predetermined applications. Likewise, when the reliability of the classification result is less than the predetermined reference value, the computing device or system may be controlled to discard the classification result, or the computing device or system may be controlled to use the result of the classification with the performance of a second predetermined operation.

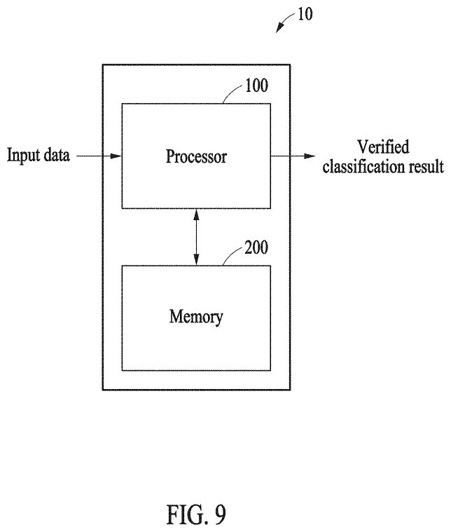

As a non-limiting example, FIG. 9 illustrates an example of a computing device or system 10 that includes a processor 100 and a memory 200.

The processor 100 is configured to capture or request input data, implement the classification neural network 101 with respect to the input data, and implement the verification neural network 102 to verify the output of the classification neural network 101, verify whether the output of the classification neural network 101 is sufficiently accurate or not, for example. The processor 100 may further be configured to merely output the verified output of the classification neural network 101, for example. Examples also include the processor 100 controlling the computing device or system to output the output of the classification neural network 101, an output of whether the output of the classification neural network 101 is verified, whether one or more other applications should be performed with the verified output of the classification neural network 101, and/or whether such one or more applications being performed by the computing device or system 10 should rely on the output of the classification neural network 101. Examples also include the computing device or system 10 being configured to request and/or capture new input data to re-perform the classification of the new input data when the verification neural network 102 indicates that the output of the classification neural network 101 is not verified, as non-limiting examples. The output of the computing device or system 10 may additionally, or alternatively, be an output of such one or more applications that depend on the verified output of the classification neural network 101, or other or no output may be controlled by the processor 100 to be output by the computing device or system 10 when the output of the classification neural network 101 is not verified.

The memory 200 of the computing device or system 10 may store one or more classification neural networks 101 for various applications stored in the memory 200, for example, store one or more verification neural networks 102 respectively for each of the classification neural networks 101, and store instructions, which when executed by the processor 100, configure the processor 100 to perform any one, any combination, or all operations or methods described herein with respect to FIGS. 1-9.

Returning to FIG. 1, a verification neural network 102, may be defined or configured separately from the classification neural network 101, and may be used to determine whether the classification result output from the classification neural network 101 is reliable. The verification neural network 102 may determine the reliability by considering information derived from/in the performance of the classification neural network 101. For example, when the input data is an image, the classification neural network 101 may perform a classification process of determining which of multiple objects and/or patterns the image represents, and the verification neural network 102 may determine a reliability of the classification result of the classification neural network 101.

For example, the verification neural network 102 may determine a reliability of a classification result using intermediate hidden values collected from/during the performance of the classification neural network 101. In this example, an intermediate hidden value may include hidden values of a hidden layer selected or predetermined among a plurality of hidden layers of the classification neural network 101. Similarly, intermediate hidden values of the classification neural network 101, e.g., with respect to training data input to the classification neural network 101, may also be used to train the verification neural network 102.

In an example, the verification neural network 102 may be trained to calculate increasing reliabilities for classification results corresponding to there being increasing similarities between training data used to train the classification neural network 101 and training data used to train the verification neural network 102, compared to the verification neural network 102 being trained to calculate decreasing reliabilities for classification results corresponding to there being decreasing similarities between training data used to train the classification neural network 101 and training data used to train the verification neural network 102.

When both the classification neural network 101 and the verification neural network 102 have been trained, e.g., trained together, and when an input data to be classified is input, the classification neural network 101 may derive a classification result of the input data, and the verification neural network 102 may calculate a reliability of the classification result of the input data.

As described above, when the verification neural network 102 calculated reliability of the classification result output from the classification neural network 101 satisfies a predetermined reference value, the reliability of the classification result may be approved and the classification result may be utilized in one or more further applications of the underlying computing device or system. When the reliability of the classification result does not satisfy the predetermined reference value, the classification result output from the classification neural network 101 may not be utilized in at least one of the one or more further applications, or not used in any of the one or more further applications, or an alternate predetermined action may be performed.

Referring to FIG. 1, the classification neural network 101 may be trained for a classification process or objective based on training data. The verification neural network 102 may be trained on a process of calculating a reliability of each of the corresponding training classification results determined by the classification neural network 101 using corresponding intermediate hidden values of the classification process of the classification neural network 101.

When the training of both of the classification neural network 101 and the verification neural network 102 is complete, input data is input to the classification neural network 101 and the classification neural network 101 may output a corresponding classification result of the input data, and the verification neural network 102 may calculate a reliability of the classification result of the input data. The above-described respective training processes based on respective training data, and the processes of performing or implementing of the trained classification neural network 101 and the verification neural network 102 may be performed by a computing device or computing system, i.e., which includes hardware, for example, a processor and a memory, such as described above with respect to FIG. 9, as a non-limiting example. For example, any combination of one or more computing devices or systems may perform any combination of the training of the classification neural network 101, the training of the verification neural network 102, the performing of the trained classification neural network 101, and the performing of the trained verification neural network 102. Also, with respect to any references to training apparatuses, devices, or systems, examples also exist where the training apparatuses, devices, or systems may also perform or implement the trained classification neural network 101 and/or the trained verification neural network 102. Likewise, with respect to any apparatuses, devices, or systems that perform the trained classification neural network 101 and/or the trained verification neural network 102, examples also exist where these apparatuses, devices, or systems may also train the classification neural network 101 and/or train the verification neural network 102.

In addition, below, for simplicity of explanation, when either of the classification neural network 101 and the verification neural network 102 are being trained using training data, the explanation will refer to the respective trainings, while other references to the classification neural network 101 and/or verification neural network 102, which do not specifically refer to the respective trainings, are references to the classification neural network 101 and the verification neural network 102 having already been trained. Similarly, references to either of the classification neural network 101 and the verification neural network 102, and/or either of the trained classification neural network 101 and the trained verification neural network 102, performing their respective inference operations is also a reference to the implementation or performance of the respective classification neural network 101 and verification neural network 102 that have already been trained. In addition, below discussions of operations performed during the training of either or both of the classification neural network 101 and the verification neural network 102, should also be considered as also being performed in an example trained classification neural network 101 and/or trained verification neural network 102, unless the corresponding context of the discussion requires otherwise. Likewise, below discussions of inference operations of either or both of the classification neural network 101 and the verification neural network 102, and/or operations of either or both of the trained classification neural network 101 and the trained verification neural network 102, should also be considered as also being performed in an example training of the classification neural network 101 and/or training of the verification neural network 102, unless the corresponding context of the discussion requires otherwise.

FIG. 2 illustrates an example of unreliable classification results determined by a classification neural network.

FIG. 2 illustrates examples of classification results of input data derived by an example classification neural network. For example, FIG. 2 illustrates a result obtained by respectively classifying each of the illustrated eight image patches by the example classification neural network. Referring to FIG. 2, the classification neural network may operate as trained, for determining or inferring which object or pattern is represented in each image patch. For example, with respect to the classification neural network 101 of FIG. 1, an input data is processed by the classification neural network 101, e.g., including respective processing of a plurality of hidden layers of the classification neural network 101, a score of each of a plurality of classes (for example, patterns 1, 2, . . . , and N) may be determined, and the class output with the highest score may be determined to be the classification result of the input data.

Thus, FIG. 2 demonstrates a corresponding classification result for each illustrated input image patch. For example, with respect to FIG. 2, the example classification neural network may be configured to output classification results for each of the illustrated image patches input to the classification neural network, e.g., classifying each image patch as one of a centipede class, a peacock class, a jackfruit class, a bubble class, a king penguin class, a starfish class, a baseball class, and an electric guitar class. However, as noted above, the corresponding input patches in FIG. 2 do not appear to be related to the corresponding indicated classes, nor any of the other centipede, peacock, jackfruit, bubble, king penguin, starfish, baseball, and electric guitar classes. For example, the input image patch corresponding to the indicated baseball class does not appear similar to a baseball, and does not appear similar to what might be expected in a corresponding training data that might have been used to train the classification neural network with respect to the baseball class. Rather, in this example, each illustrated input patch corresponds to an intentional fooling or spoofing attempt of the example classification neural network, where each image has been designed to result in the corresponding incorrect classification result. In this example, the incorrect classification results are unreliable results.

Rather, in one or more examples, such input patches may be input to the classification neural network 101 and the reliability of each resultant classification result may be considered by the verification neural network 102 provided the intermediate hidden value(s) of the classification neural network 101 during the respective classification operations of the classification neural network 101. For example, if the illustrated image patch corresponding to the baseball classification result in FIG. 2 were to be input to the classification neural network 101, the verification neural network 102 may calculate a reliability for the baseball class result of the corresponding input image patch as a score between 0 and 1, e.g., according to whichever of the 0 and 1 represents no or low reliability, while also noting that outputs of the classification neural network 101 and/or the verification neural network 102 may alternatively be in the form of one hot outputs, as non-limiting examples.

Returning to FIG. 1, the verification neural network 102 may determine a reliability of the classification result of the input data derived from the classification neural network 101, using intermediate hidden values that may be resultant values of one hidden layer or resultant values of two or more hidden layers among the plurality of hidden layers of the classification neural network 101. Herein, the intermediate hidden value(s) may be, for example, hidden values derived from one of the plurality of hidden layers or otherwise resultant values of the one of the plurality of hidden layers of the classification neural network 101, or respective hidden values derived from any combination of two or more of the plurality of hidden layers or otherwise respective hidden values of any combination of two or more plurality of hidden layers of the classification neural network 101. Here, even though examples are provided using such respective intermediate hidden values of one or more hidden layers of the classification neural network 101, examples also include such two or more hidden layers being contiguous or sequential hidden layers, some of the intermediate hidden values being of such contiguous or sequential hidden layers and some of the intermediate hidden values being of other hidden layer(s) non-contiguous or non-sequential with the example contiguous or sequential hidden layers, or the intermediate hidden values may be from/of one or more hidden layers that are not respectively contiguous or sequential with respect to each other. As a non-limiting example, hidden values of a current hidden layer may be a resultant feature vector or activation vector generated, by the current hidden layer, based on an activation by the current hidden layer with respect to another layer's input/output to the current hidden layer, and/or with respect to an input/output of the current hidden layer at a previous or subsequent time. As a non-limiting example, hidden values of a current hidden layer may be a resultant feature map or activation map generated by a convolution of one or more filters applied to an input to the current hidden layer, e.g., the current hidden layer may generate (or output) an activation result of the current hidden layer with respect to the convolution of a previous layer's output that is input to the current hidden layer, and/or with respect to the convolution of an input/output to itself of activation result(s) at a previous or subsequent time. Further, while examples are provided where the verification neural network 102 is described as verifying the classification output of the classification neural network 101 based on intermediate hidden values of hidden layer(s) of the classification neural network 101, examples are not limited to the consideration of only intermediate hidden values of the hidden layer(s) in determining the reliability of the classification output of the classification neural network 101.

Accordingly, in an example, to consider whether the classification result is available for other applications, whether the classification result should be made available for other applications, or whether such other applications that called or are using the classification neural network 101 should otherwise continue or cease operation, the verification neural network 102 set separately, for example, from the classification neural network 101 may calculate the reliability of the classification result of the input. When the reliability is high, the classification result may be provided to the other applications, the classification result may be available to the other applications, or such other applications that called or are using the classification neural network 101 may continue operation based on the classification result being verified. However, when the reliability is low, the classification result may not be provided to the other applications, the classification result may not be available to the other applications, such other applications that called or are using the classification neural network 101 may cease operation, and/or other operations may be performed with respect to the unreliable determination of the classification result.

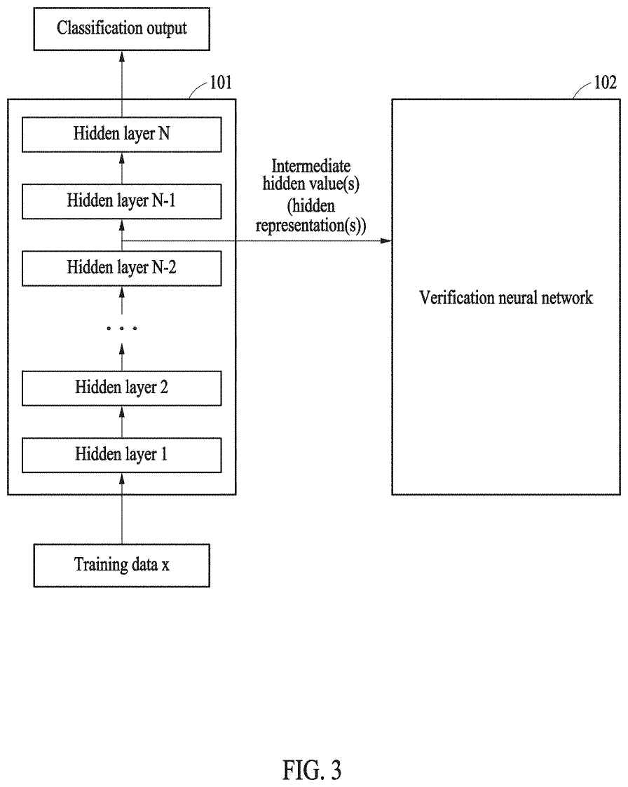

FIG. 3 illustrates an example of a process of training a verification neural network.

A classification process of the classification neural network 101 and a determination of a reliability of the verification neural network 102 may be performed by a computing device that includes a processor and a memory, as a non-limiting example. Referring to FIG. 3, to learn the classification process of the classification neural network 101, training data may be input to the classification neural network 101.

In an example, when training data x inputs to the classification neural network 101, and as each of the plurality of hidden layers perform their respective operations, the classification neural network 101 may be trained by updating parameters of each of the hidden layers, corresponding to each respective node of each of the hidden layers, such as by performing backpropagation of a calculated error between a label of a classification result of the training data x and an output of the classification result of the classification neural network 101. For example, with respect to the updating of such parameters, the classification neural network 101 may be optimized by updating weights of respective filters applied in each of the plurality of hidden layers, to ultimately accurately determine which object or pattern the training data x represents through a training process.

The verification neural network 102 may be trained to calculate a reliability of a classification result of the classification neural network 101. For a training process of the verification neural network 102, intermediate hidden values (for example, a hidden representation) determined by the classification neural network 101 may be used. In an example, when the classification neural network 101 includes “N” hidden layers, hidden values of a hidden layer corresponding to a predetermined operation may be set as an intermediate hidden values of the classification neural network 101. To learn a process of determining a reliability, the verification neural network 102 may use intermediate hidden values of one or more hidden layers of the classification neural network 101.

In FIG. 3, intermediate hidden values of the classification neural network 101 may include hidden values of a hidden layer (for example, a hidden representation) of an (N−2)-th hidden layer may be used to train the verification neural network 102. In other words, in one or more non-limiting examples, the classification neural network 101 and the verification neural network 102 may be simultaneously trained. For example, the classification neural network 101 may be trained by updating parameters of each of the hidden layers of the classification neural network 101 using a backpropagation process repeatedly being performed based on training data being applied to the classification neural network 101. The verification neural network 102 may also be trained using the corresponding hidden values of a hidden layer of the classification neural network 101 during training of the classification neural network 101, e.g., for the corresponding labeled or known classification result of the classification neural network 101 for each training data.

Although hidden values of a hidden layer of the classification neural network 101 is discussed above for the training of the verification neural network 102, this is just one example of the training of the verification neural network 102, as examples also include the training of the verification neural network 102 using hidden values of two or more hidden layers of the classification neural network 101 to train the verification neural network 102. For example, as discussed above, the various examples of the various combinations of hidden layers of the classification neural network 101 with the inference operations of the trained classification neural network 101 and the inference operations of the trained verification neural network 102 are similarly available in the example trainings of the classification neural network 101 and verification neural network 102.

As another example, as also discussed above with respect to the inference operations of the trained classification neural network 101 and the inference operations of the trained verification neural network 102, examples include a plurality of verification neural networks 102 being trained and resultantly configured to perform the respective reliability determination for the classification result of the trained classification neural network 101. In such an example, hidden values of different hidden layers among the hidden layers included in the classification neural network 101 may be set as respective intermediate hidden values and respectively implemented/provided as the input values of different verification neural networks 102, and a final reliability of a classification result of the classification neural network 101 may also be derived by combining (for example, averaging) reliabilities calculated in the plurality of verification neural networks 102. Such plural verification neural networks 102 may operate in parallel. Such plural verification neural networks 102 may operate hierarchically, e.g., based on a positive reliability determination of one verification neural network 102, a next verification neural network 102 is then implemented. In addition, some of the plural verification neural networks 102 may operate in parallel and some of the plural verification neural networks 102 may operate hierarchically.

In another example, as also noted above, hidden values of different hidden layers may be input to one verification neural network 102. In this example, the one verification neural network 102 may calculate a reliability of a classification result by combining the hidden values of two or more pre-selected hidden layers. In other words, intermediate hidden values of each of two or more hidden layers among “N” hidden layers of the classification neural network 101 may be input to the verification neural network 102. Also, hidden values of two or more hidden layers may be combined (for example, summed, averaged, weighted sums, or weighted averages, as non-limiting examples) and the result of the combination may be input to the verification neural network 102, and the verification neural network 102 may derive a reliability of the classification result of the classification neural network 101 based on a result obtained by the combining of the hidden values of the two or more hidden layers. As an example of a combination of hidden values of hidden layer(s) based on weighted sums or weighted averages, the hidden values of the hidden layers that are closer to the output layer may be given a relatively higher weight than hidden values of the hidden layer(s) that are closer to the input layer.

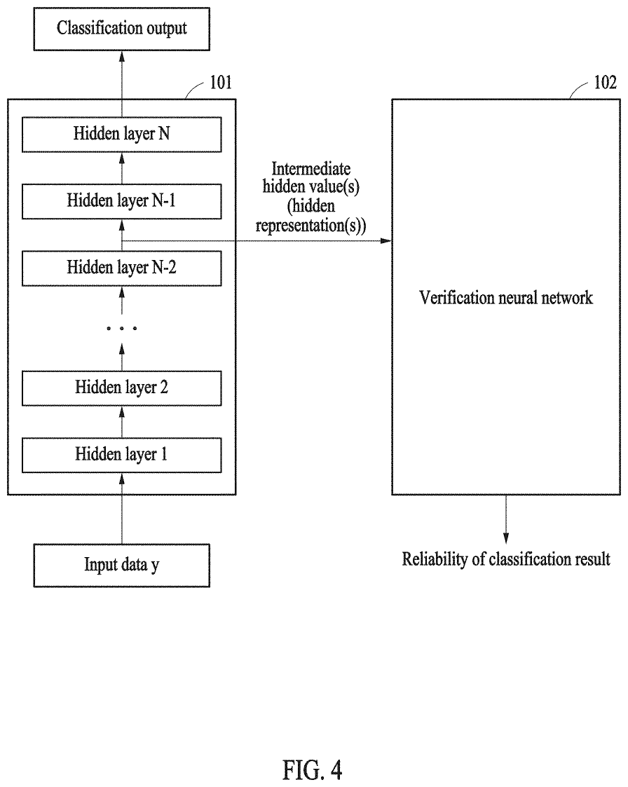

FIG. 4 illustrates an example of a process in which a verification neural network determines a reliability of a classification result.

Input data y to be classified as a predetermined class, among a plurality of classes classifiable by the classification neural network 101, may be input to the classification neural network 101 trained as described above with reference to FIG. 3, as a non-limiting example. The classification neural network 101 may implement the operations/processes of each of the hidden layers of the classification neural network 101, e.g., in response to the input of the input data y. The classification neural network 101 may classify the input data y into one of the plurality of classes through the processes of the hidden layers of the classification neural network 101, to output a classification result.

The verification neural network 102 may determine a reliability of the classification result of input data processed by the classification neural network 101. In an example, the verification neural network 102 may determine a reliability of the classification result, for the input data, as output from the classification neural network 101 using intermediate hidden values of one or more hidden layers of the classification neural network 101.

In an example, the verification neural network 102 may compare a reliability of a classification result for the input data and a reference value. In an example, when the reliability is greater than or equal to the reference value, the verification neural network 102 may determine that the classification result, for the input data, output from the classification neural network 101 is reliable. In another example, when the reliability is less than the reference value, the verification neural network 102 may determine that the classification result, for the input data output, from the classification neural network 101 is unreliable. In this example, the verification neural network 102 may reject the classification result of the classification neural network 101 for the input data and the computing device or system may be controlled to perform a predetermined operation, e.g., requesting another input data, and/or merely not perform or continue other predetermined operations, such as face recognition, that rely on reliable classification results.

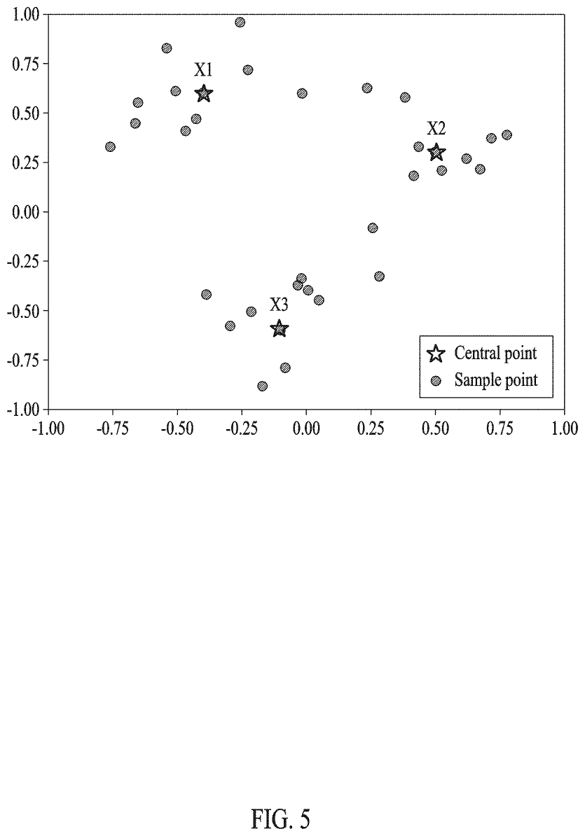

FIG. 5 illustrates an example of a process of determining a score of a sample point to train a verification neural network.

To train the verification neural network 102 that determines a reliability of a classification result of the classification neural network 101, intermediate hidden values of the classification neural network 101, e.g., hidden values of one or more of a plurality of hidden layers of the classification neural network 101, may be used. FIG. 5 illustrates a domain of the intermediate hidden values.

In an example, when training data is input to the classification neural network 101, a hidden representation of one hidden layer or hidden representations of two or more hidden layers, pre-selected from the plurality of hidden layers of the classification neural network 101, may be set as the intermediate hidden values of the classification neural network 101 and may be used to train the verification neural network 102.

In FIG. 5, central points X1 to X3 may be points corresponding to the intermediate values of the plurality of hidden layers of the classification neural network 101, when three different pieces of training data are input to the classification neural network 101. In other words, each central point may be associated with a corresponding training data that is being used to train the classification neural network 101.

Also, in an example, a sample point may be a point randomly generated around each central point. For example, the sample points are virtual sample points that may be virtually generated based on the real training data used for training, and the central points, corresponding to the real training data, and the virtual sample points, corresponding to virtual training data, may be used to train the verification neural network 102. For example, sample points may be associated with virtual sample data having attributes similar to those of a real training data, e.g., sample points of virtual training data of FIG. 5 may be newly generated corresponding a central point of a real training data through Gaussian sampling.

In other words, the verification neural network 102 may generate respective sample data having scoring similar to each training data, to cover input data including a variety of information to be actually classified. Thus, the above sample points and central points associated with training data used to train the classification neural network 101 may be used to train the verification neural network 102.

The classification neural network 101 may determine a score of each of a central point and one or more sample points. Here, the score may be a score of a class of data to be classified at a predetermined point. For example, when the classification neural network 101 classifies training data of the central point X1 as one of a class 1 (dogs), a class 2 (cats), a class 3 (pigs), and a class 4 (chickens), a score of the central point X1 may be a score to determine a predetermined class (for example, cats of the class 2) as the classification result for the particular training data, and the sample points around the central point X1 may correspondingly have scores with respect the same predetermined class. For example, the score of central point X1 and the scores of the sample points around the central point X1 may be representative of a classification result of the classification neural network 101 being the predetermined class, while reliability scores of the sample points surrounding the central point X1 may be representative of the determined reliability by the verification neural network 102 of these classification results (for the predetermined) corresponding to the sample points.

Scores may be determined differently depending on a selected class. For example, a first central point and corresponding first sample points may have scores corresponding a first class, and second first central point and corresponding second sample points may have scores corresponding a second class, such as illustrated in FIG. 5 where sample points around the central point X1 are represented in the domain around the central point X1 of approximately position (−0.4, 0.6) of the domain, while sample points around the central point X2 are represented in the domain around, or clustered with, the central point X2 at approximately position (0.5, 0.3) of the domain.

Thus, the verification neural network 102 may receive a hidden representation, including intermediate hidden values of the classification neural network 101, and a score of a central point corresponding to the hidden representation from the classification neural network 101 for a training data. Also, the verification neural network 102 may determine a score of the one or more sample points randomly, for example, generated around the central point. In this example, each score of each sample point generated around the central point may be higher or lower than the score of the central point for a predetermined class. In other words, in one or more examples, the score of the central point may not always need to be higher than the score of the sample point.

A process of training the verification neural network 102 may be performed based on a score of each of the central point and the sample point(s).

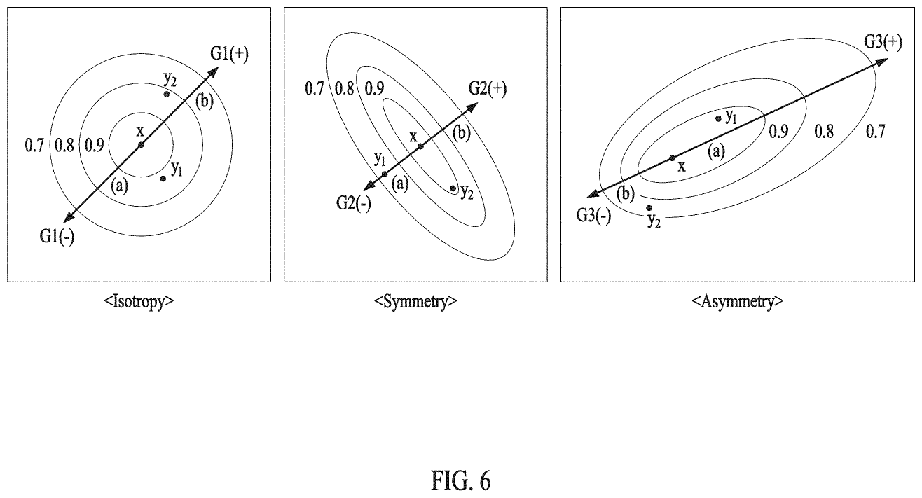

FIG. 6 illustrates examples of reliability models that may be used to train a verification neural network to determine a reliability of a classification result.

FIG. 6 illustrates three types of reliability models. A reliability model may be expressed by contour lines, and may determine a reliability of sample data used to train the verification neural network 102. Here, the sample data, as data corresponding to the sample point(s) of FIG. 5, may be data randomly generated for training data.

For example, a reliability of a sample point corresponding to predetermined sample data may be determined from a selected reliability model. The reliability model may indicate that a reliability decreases when a distance between a central point corresponding to training data and a sample point corresponding to sample data increases. In an example, the central point may have a reliability of 1, a first contour line close to the central point may represent a reliability of 0.9, and a second contour line, farther from the central point than the first contour line, may represent a reliability of 0.8.

As non-limiting example, a reliability model may be a first model that determines a reliability of a sample point based on a distance between the sample point and a central point corresponding to training data, or may be a second model that determines a reliability of a sample point based on a distance between the sample point and a central point corresponding to training data and based on a gradient direction of the central point that is considered to be attribute information of the training data, e.g., in this example the attribute information of the training data may be a gradient direction of the central point. In FIG. 6, an isotropy model may correspond to the first model, and a symmetry model and an asymmetry model may correspond to the second model.

Reliability models of the verification neural network 102 may be used to determine a reliability of data to train the verification neural network 102, and may be the isotropy model, the symmetry model, and the asymmetry model, as non-limiting examples. These three example reliability models may be determined or selected for use in the training based on a type of training data (for example, in an example where the training (and inference input) data is audio data, or where the training (and inference input) data is image data), the size (for example, a number of hidden layers) of the classification neural network 101, or a type of the classification neural network 101, e.g., whether the classification neural network 101 is a convolutional neural network type, or another type.

In particular, a scheme of determining a reliability of data to be used to train the verification neural network 102, e.g., based on a gradient and/or a distance to a central point X corresponding to training data, is described with reference to FIG. 6. Gradients G1, G2, and G3 of FIG. 6 may each be information indicating respective degree of sharp changes (increase or decrease) in scores from a central point to each sample point of the central point.

The gradient may be set as one direction in which a score of a sample point significantly increases or decreases among several directions for the central point X. For example, a positive (+) gradient may represent a direction in which a score of a sample point most significantly increases around the central point, while a negative (−) gradient may represent a direction in which a score of a sample point most significantly decreases around the central point. The gradient may be set based on the training data, and as noted above, the example gradient may be considered attribute information of the training data.

In the isotropy model of FIG. 6, a reliability distribution is represented in forms of contour lines forming concentric circles around a central point X. In the isotropy model, the gradient G1 for the central point X may be set, however, a reliability may be determined only for a distance to the central point X. Here, in the isotropy model, sample points located at the same distance from the central point X may be determined to have the same reliability.

In the isotropy model, sample points y1 and y2 may be assumed to be the same distance from the central point X. However, as illustrated in FIG. 6, since the sample point y2 is closer to the gradient G1 of the central point X than the sample point y1, the score of the sample point y2 may be determined/assigned to be higher than that of the sample point y1. The sample points y1 and y2 may refer to virtual hidden values (for example, hidden representations) of hidden layers as if a corresponding virtual first input data and second input data had been input to the classification neural network 101, respectively.

However, in the isotropy model, the same reliability may be designated for sample points located at the same distance from the center point X, regardless of a gradient for the center point X, e.g., regardless of the differences in the gradient dependent scores of the sample points. In other words, a reliability of the sample point y1 and a reliability of the sample point y2 may be determined to be the same as a reliability of about 0.85, e.g., because the sample points y1 and y2 fall between the first concentric circle corresponding to a reliability of 0.9 and the second concentric circle corresponding to a reliability of 0.8.

In a symmetry model of FIG. 6, a reliability distribution is represented in forms of contour lines forming ellipses around a central point X. In the symmetry model, a gradient G2 for the central point X may be set. Here, the gradient G2 may refer to a direction in which the assigned scores of the sample points most sharply change around the central point X (in the case of G2(+), the scores increase, and in the case of G2(−), the scores decrease). Here, in the symmetry model, a reliability may be set to be relatively more quickly changed for a direction in which a score is sharply changed.

In other words, based on the symmetry model, a sharp change in the score may indicate that it is difficult to set a high reliability for a classification result. That is, in the symmetry model, reliabilities of sample points located at the same distance from the central point X may be determined/assigned differently based on whether the sample points are close to the gradient direction. Thus, the symmetry model may take into consideration a reliability according to a degree of change in scores of sample points.

In the symmetry model, while sample points y1 and y2 may be assumed to be the same distance from the central point X, since the sample point y1 located closer to the gradient G2 for the central point X between the sample points y1 and y2 has a greater score difference from the central point X than the sample point y2, a reliability of the sample point y1 may be determined to be less than a reliability of the sample point y2. In the symmetry model, due to the greatest degree of change in scores for a gradient direction of the central point X, the greatest degree of a change in a reliability may appear and a narrowest gap between contour lines may be determined.

In an asymmetry model of FIG. 6, a reliability distribution is represented in forms of atypical contour lines around a central point X. In the asymmetry model, a gradient G3 for the central point X may be set. Here, the gradient G3 may refer to a direction in which scores are determined/assigned to be most sharply change around the central point X (in the case of G3(+), the scores increase, and in the case of G3(−), the scores decrease). Here, in the asymmetry model, a high reliability may be set for a direction (a direction of a positive (+) gradient) in which scores of sample points sharply increase, unlike the symmetry model. A low reliability may be set for a direction of a negative (−) gradient that is opposite to the direction of the positive (+) gradient.

By the asymmetry model, a sharp increase in scores of sample points may indicate that a high reliability is set due to a high probability when classified into classes. Thus, as a sample point approaches a gradient G3(+), a reliability of the sample point may be determined to increase. Since a score of a target point most significantly decreases as the target point approaches a gradient G3(−), a reliability of a sample point may be determined to decrease.

In other words, in the asymmetry model, a reliability may be determined differently depending on whether sample points located at the same distance from the center point X are close to a gradient direction. The asymmetry model may take into consideration a reliability based on a score of a target point.

In the asymmetry model, sample points y1 and y2 may be assumed to be the same distance from the central point X. Here, the sample point y1 located closer to the gradient G3 for the central point X between the sample points y1 and y2 may have a greater score difference from the central point X than the sample point y2. Accordingly, a reliability (a) of the sample point y1 may be determined to be greater than a reliability (b) of the sample point y2. Also, in the asymmetry model, due to the greatest degree of change in scores for a direction of the gradient G3 (+) direction of the central point X, the smallest degree of a change in a reliability may be determined.

As a sample point approaches the gradient G3(+) even though sample points are located at the same distance from the center point X, a degree of a decrease in a reliability from the center point X may decrease. Thus, a widest gap between the contour lines may be determined in the direction of the gradient G3(+) in the asymmetry model. However, as a sample point approaches the gradient G3(−) even though the sample points are located at the same distance from the central point X, the degree of the decrease in the reliability from the central point X may increase. Thus, in the asymmetry model, a narrowest gap between the contour lines may be determined in the direction of the gradient G3(−).

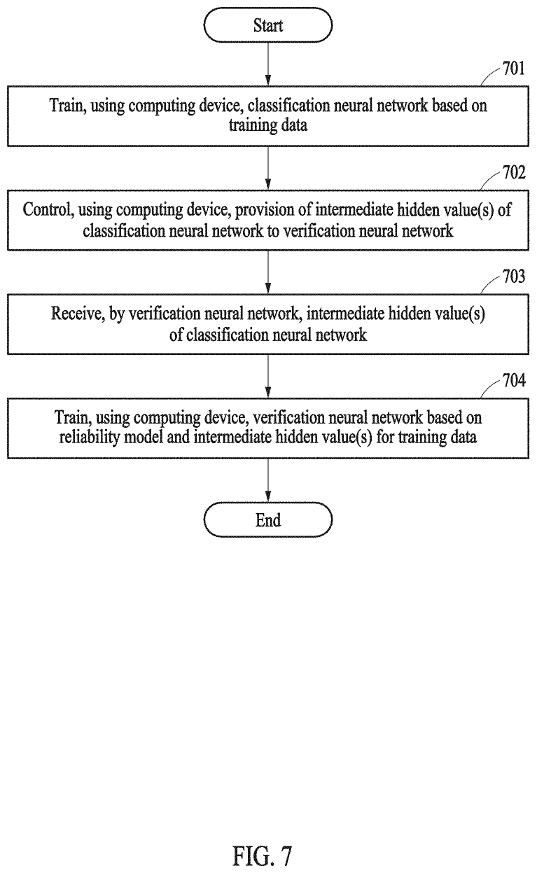

FIG. 7 is a flowchart illustrating an example of a process of training a verification neural network.

In operation 701, a computing device may train the classification neural network 101 based on training data.

In operation 702, the computing device may control intermediate hidden values of the classification neural network 101 to be provided to the verification neural network 102. The intermediate hidden values of the classification neural network 101 may include hidden values of one hidden layer or hidden values of two or more hidden layers of the classification neural network 101 determined when training data is processed in the classification neural network 101.

In operation 703, the verification neural network 102 may receive the intermediate hidden values from the classification neural network 101.

In operation 704, the computing device may train the verification neural network 102 based on a reliability model and the intermediate hidden values for the corresponding training data.

The computing device may determine a reliability model to designate a reliability of sample data to be used to train the verification neural network 102, using the intermediate hidden values of the classification neural network 101, and may train the verification neural network 102 based on the determined reliability model and the sample data.

Here, the reliability model may randomly generate a plurality of sample points around a central point corresponding to the intermediate hidden values of the classification neural network 101 and may be generated using scores of the sample points.

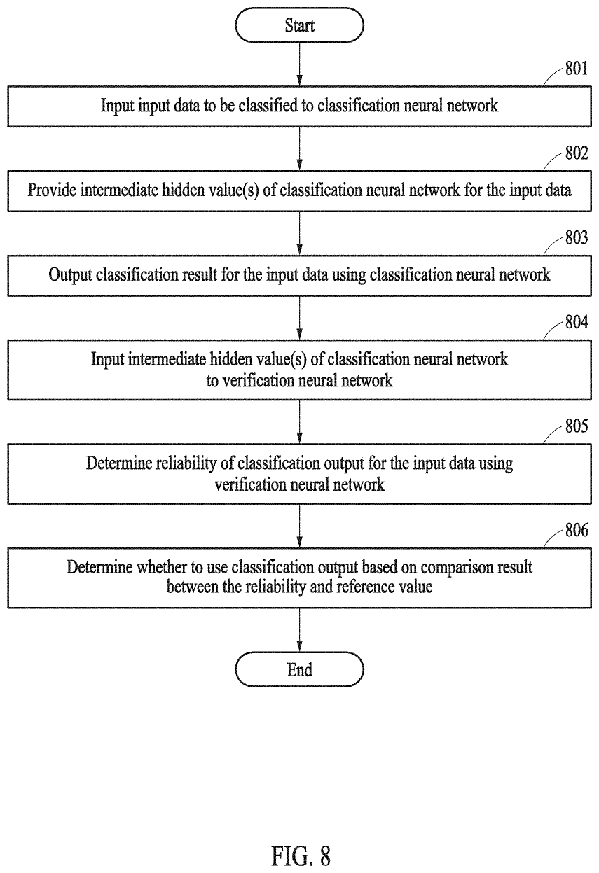

FIG. 8 is a flowchart illustrating an example of a process in which a verification neural network determines a reliability of a classification result of input data. The process of FIG. 8 may be performed using the classification neural network 101 and the verification neural network 102 that have already been trained, e.g., completely trained to a predetermined accuracy and/or inaccuracy.

In operation 801, the computing device may input input data to be classified to the classification neural network 101. For example, the computing device may be the computing device or system 10 of FIG. 9 described above, noting that all discussed computing devices described herein may also correspond to the computing device or system 10 of FIG. 9, though examples are not limited thereto.

In operation 802, the computing device may implement the classification neural network 101 for the input data. In this implementation of the classification neural network 101, intermediate hidden values of the classification neural network 101 are generated, as the classification neural network 101 operates to generate/output the result of the classification for the input data.

In operation 803, the computing device may output the classification result for the input data based on the use/implementation of the classification neural network 101 in operation 802. The classification result may be a final class indicated by a final or output layer of the classification neural network 101, for example. For example, when the input data is an image, the classification result may be one of a plurality of classes, for example, dogs, cats, airplanes, ships, people, traffic lights, vehicles, or bicycles, etc., as non-limiting examples.

In operation 804, the computing device may input the intermediate hidden values of the classification neural network 101, for the input data, to the verification neural network 102. The intermediate hidden values of the classification neural network 101 may be hidden values of one (or more) of a plurality of hidden layers included in the classification neural network 101, as discussed above.

In operation 805, the computing device may determine a reliability of the classification result, for the input data, using the verification neural network 102.

In operation 806, the computing device may compare the reliability of the classification result of the input data to a predetermined reference value and may determine whether to use the classification result of the input data. For example, when the reliability of the classification result of the input data exceeds the predetermined reference value, the computing device may output the classification result of the input data, or provide the classification result to other applications of the computing device. In another example, when the reliability of the classification result of the input data is less than the predetermined reference value, the computing device may reject the classification result of the input data, or may perform another predetermined action, such as requesting a new input data from a user for a reconsideration by the classification neural network 101.

Herein, although operations or methods may be depicted in a specific order in the drawings, it should be understood that the operations or methods are not required to be performed in the depicted specific orders or sequenced orders, as embodiments include all alternate orders and sequencing of the operations and methods, unless such alternate orders and sequencing are inconsistent with the above description and operation of any of various embodiments. In addition, the operations and methods described herein may be performed partially, or in various portions, or wholly with multitasking and/or parallel processing and corresponding processor(s) of the computing device or system 10 of FIG. 9, as a non-limiting example. In addition, it should be understood that there is no requirement that embodiments only separately include any separately described operations, methods, components, apparatuses, or systems in the above disclosure, but rather, it should be understood that various embodiments include those with any of the above described operations, methods, components, apparatuses, and systems each being respectively performed by two or more separated operations, methods, components, apparatuses, and systems, and it should be understood that various embodiments also include those with any of the above described operations, methods, components, apparatuses, and systems being respectively combined as any combination of the above described operations, methods, components, apparatuses, and systems. It should be further understood that, with respect to any of the above operations and methods, of any of the components, apparatuses, and systems, embodiments herein also include any combination of the respective operations, methods, or functions implemented through respective one or more hardware, or through a single hardware, using any combinations of one or more non-transitory computer readable media, such as the memory 200 of the computing device 10 of FIG. 9, having stored therein correspondingly respective instructions or respective software products, or instructions packaged as a single software product, or as single product, and one or more of the classification neural networks 101 as well as, for each of the classification neural networks 101, one or more verification neural networks 102.

The computing devices, computing systems, processors, memories, and other apparatuses, modules, devices, and other components described herein with respect to FIGS. 1-9 are implemented by hardware components. Examples of hardware components that may be used to perform the operations described in this application where appropriate include controllers, sensors, generators, drivers, memories, comparators, systolic arrays and the like, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers, e.g., in cooperation with one or more systolic arrays as non-limiting examples. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods of FIGS. 1-9 that perform the operations described in this application are performed by computing hardware, for example, by one or more processors or computers, implemented as described above executing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, as well as one or more systolic arrays in combination therewith as a non-limiting example, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions used herein, which disclose algorithms for performing the operations that are performed by the hardware components and the methods as described above.

The instructions or software to control computing hardware, for example, one or more processors or computers, as well as one or more systolic arrays in combination therewith, to implement the hardware components and perform the methods as described above, and any associated data, data files, and data structures, may be recorded, stored, or fixed in or on one or more non-transitory computer-readable storage media. Examples of a non-transitory computer-readable storage medium include read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

What is claimed is:

1. A processor-implemented method, the method comprising:
implementing a classification neural network to generate a classification result of data input to the classification neural network by:
generating, with respect to the input data, intermediate hidden values of one or more hidden layers of the classification neural network; and
generating the classification result of the input data based on the generated intermediate hidden values; and
generating a determination of a reliability of the classification result by implementing a verification neural network, input the intermediate hidden values, to generate the determination of the reliability.

2. The method of claim 1, wherein the intermediate hidden values include hidden values of two or more hidden layers, as respective outputs of the two or more hidden layers, among a plurality of hidden layers of the classification neural network.

3. The method of claim 1, further comprising:
verifying the classification result of the input data when the generated determination of the reliability of the classification result meets a predetermined verification threshold.

4. The method of claim 3, further comprising:
selectively controlling performance of operations of a computing device based on whether the classification result is verified.

5. The method of claim 1, wherein the verification neural network comprises at least five hidden layers.

6. The method of claim 1, wherein the classification neural network comprises at least five hidden layers.

7. The method of claim 1, further comprising training a temporary verification neural network, to become the verification neural network, by inputting to the temporary verification neural network hidden values of the classification neural network corresponding to a training data and a known reliable classification result of the classification neural network corresponding to the training data, and adjusting parameters of the temporary verification neural network toward generating an accurate verification of the known reliable classification result.

8. The method of claim 7, further comprising generating sample data from the training data,
wherein the temporary verification neural network is trained based on attribute information of the training data and a distance between the training data and the sample data using a reliability model.

9. The method of claim 8, wherein, in the reliability model, a reliability decreases when a distance between a central point corresponding to the training data and a sample point corresponding to sample data increases.

10. The method of claim 7, wherein the training of the temporary verification neural network further comprises using either:
a first reliability model that determines a reliability of a sample point corresponding to sample data with an attribute similar to the training data based on a distance between the sample point and a first central point corresponding to the training data; or
a second reliability model that determines a reliability of the sample point corresponding to the sample data with another attribute similar to the training data based on a distance between the sample point and a second central point corresponding to the training data and based on a gradient direction of the central point that is attribute information of the training data.

11. The method of claim 7, further comprising obtaining a score of a central point corresponding to the hidden values of the classification neural network corresponding to the training data, determining a score of a sample point corresponding to sample data randomly generated around the central point, and performing the training of the temporary verification neural network based on the score of the central point and the score of the sample point.

12. The method of claim 1, further comprising training a temporary classification neural network, with respect to a training input, to become the classification neural network, and training a temporary verification neural network, to become the verification neural network,
wherein the training of the temporary verification neural network includes inputting intermediate hidden values of the temporary classification neural network, with respect to the training input, to the temporary verification neural network with respect to a training classification result of the temporary classification neural network for the training input.

13. A non-transitory computer readable medium comprising instructions, which when executed by a processor, configure the processor perform the method of claim 1.

14. A processor-implemented method, the method comprising:
generating, with respect to training data input to a classification neural network, intermediate hidden values of one or more hidden layers of the classification neural network;
training the verification neural network based on a reliability model and the intermediate hidden values.

15. The method of claim 14, further comprising:
implementing the trained classification neural network to generate a classification result of input data through respective processes of one or more hidden layers of the trained classification neural network;
implementing the trained verification neural network, input hidden values of the respective processes of the one or more of hidden layers, to generate a determination of a reliability of the classification result.

16. The method of claim 14, wherein the training of the verification neural network is based on attribute information of the training data and a distance between the training data and sample data generated, from the training data, using the reliability model.

17. The method of claim 14, further comprising obtaining a score of a central point corresponding to the intermediate hidden values, determining a score of a sample point corresponding to sample data randomly generated around the central point, and performing the training of the verification neural network based on the score of the central point and the score of the sample point.

18. The method of claim 14, wherein, in the reliability model, a reliability decreases when a distance between a central point corresponding to the training data and a sample point corresponding to sample data increases.

19. The method of claim 14, wherein the training of the verification neural network further comprises using either:
a first reliability model that determines a reliability of a sample point corresponding to sample data with an attribute similar to the training data based on a distance between the sample point and a first central point corresponding to the training data; or
a second reliability model that determines a reliability of a sample point corresponding to the sample data with another attribute similar to the training data based on a distance between the sample point and a second central point corresponding to the training data and based on a gradient direction of the central point that is attribute information of the training data.

20. The method of claim 14, wherein the verification neural network comprises at least five hidden layers.

21. The method of claim 14, wherein the classification neural network comprises at least five hidden layers.

22. A non-transitory computer readable medium comprising instructions, which when executed by a processor, configure the processor perform the method of claim 14.

23. A non-transitory computer readable medium comprising:
instructions, which when executed by a processor, control the processor to implement at least one of a classification neural network and a verification neural network;
the classification neural network configured to generate a classification result of data input to the classification neural network; and
the verification neural network configured to generate a reliability determination of the classification result based on intermediate hidden values, of one or more hidden layers of the classification neural network, generated within the classification neural network by the generation of the classification result.

24. The medium of claim 23, further comprising another verification neural network configured to generate another reliability determination of the classification result based on hidden values of at least one hidden layer of the classification neural network generated within the classification neural network by the generation of the classification result, and
wherein the instructions further include instructions, which when executed by the processor, control the processor to implement the classification neural network, implement the verification neural network and the other verification neural network to determine respective reliabilities of the classification result, and determine a final reliability of the classification result based on the determined respective reliabilities.

25. A computing device, comprising:
a processor; and
a memory comprising:
a classification neural network configured to generate a classification result of data input to the classification neural network; and
a verification neural network configured to generate a reliability determination of the classification result based on intermediate hidden values, of one or more hidden layers of the classification neural network, generated within the classification neural network in the generation of the classification result,
wherein the processor is configured to selectively control operations of the computing device based on whether a result, of an implementation of the classification neural network for the input data and implementation of the verification neural network with respect to the classification result, verified the classification result.

26. The device of claim 25,
wherein the memory further comprises another verification neural network configured to generate another reliability determination of the classification result based on hidden values of at least one hidden layer of the classification neural network generated within the classification neural network by the generation of the classification result, and
wherein the selective control of the operations of the computing device are based on whether combined results, of respective implementations of the verification neural network and the other verification neural network with respect to the classification result, verified the classification result.

27. A computing device, the computing device comprising:
a processor configured to:
implement a classification neural network to generate a classification result of data input to the classification neural network by:
generation of, with respect to the input data, intermediate hidden values of one or more hidden layers of the classification neural network; and
generation of the classification result of the input data based on the generated intermediate hidden values; and
generate a determination of a reliability of the classification result by implementing a verification neural network, input the intermediate hidden values, to generate the determination of the reliability.

28. The device of claim 27, wherein the intermediate hidden values include hidden values of two or more hidden layers, as respective outputs of the two or more hidden layers, among a plurality of hidden layers of the classification neural network.

29. The device of claim 27, wherein the processor is further configured to verify the classification result of the input data when the generated determination of the reliability of the classification result meets a predetermined verification threshold.

30. The device of claim 27, wherein the processor is further configured to selectively control performance of operations of the device based on whether the classification result is verified.

31. The device of claim 27, wherein the verification neural network comprises at least five hidden layers.

32. The device of claim 27, wherein the classification neural network comprises at least five hidden layers.

33. A computing device comprising:
a classification neural network configured to generate a classification result of data input to the classification neural network;
a verification neural network configured to generate a reliability determination of the classification result based on intermediate hidden values, of one or more hidden layers of the classification neural network, generated within the classification neural network by the generation of the classification result; and
a processor configured to implement the classification neural network and the verification neural network.

34. The device of claim 33, further comprising another verification neural network configured to generate another reliability determination of the classification result based on hidden values at least one hidden layer of the classification neural network, generated within the classification neural network by the generation of the classification result,
wherein the processor is further configured to implement the other verification neural network, and to verify the classification result of the input data based on the reliability determination and the other reliability determination.

35. The device of claim 33, wherein the processor is configured to verify the classification result of the input data when the reliability determination meets a predetermined verification threshold.

36. The device of claim 35, wherein the processor is configured to selectively control performance of operations of the device based on whether the classification is verified.

37. The computing device of claim 33, wherein the classification neural network is a convolutional neural network (CNN).

38. The computing device of claim 37, wherein the classification neural network comprises at least five hidden layers.

39. The computing device of claim 33, wherein the verification neural network is a CNN.

40. The computing device of claim 39, wherein the verification neural network comprises at least five hidden layers.

41. The computing device of claim 33, wherein the input data is image data.

42. The computing device of claim 33, wherein the input data is audio data.

43. The computing device of claim 33, wherein the classification neural network comprises an input layer, an output layer, and a plurality of hidden layers, and the intermediate hidden values include outputs of a hidden layer closer to the output layer than the input layer.
